(19) United States
(12) Patent Application Publication
(10) Pub. No.: US 2016/0272809 A1
(43) Pub. Date: Sep. 22, 2016

(54) EPOXY RESIN COMPOSITION FOR OUTDOOR ELECTRICAL INSULATION AND COMPONENT FOR OUTDOOR ELECTRICAL INSULATION

(71) Applicant: Nagase ChemteX Corporation, Osaka (JP)

(72) Inventor: Hiroshi TAKEUCHI, Hyogo (JP)

(21) Appl. No.: 15/070,602

(22) Filed: Mar. 15, 2016

(30) Foreign Application Priority Data
Mar. 19, 2015 (JP) 2015-056387

(51) Int. Cl. C08L 63/00; H01B 7/282; H01B 3/40; C08G 59/24; C08G 59/42

(52) U.S. Cl. CPC C08L 63/00; C08G 59/24; C08G 59/4215; H01B 3/40; H01B 7/282; C08L 2201/56; C08L 2203/20

(57) ABSTRACT

The present invention aims to provide an epoxy resin composition having excellent liquid stability while maintaining mechanical characteristics, electrical insulating properties, and water repellency required for outdoor use as a component for electrical insulation. An epoxy resin composition for outdoor electrical insulation contains an epoxy resin (A), 0.5 to 0.99 parts by weight of a glycidyl group-containing polysiloxane (B) based on 100 parts by weight of the epoxy resin (A), and 0.1 to 1.0 part by weight of a dispersant (C) based on 100 parts by weight of the epoxy resin (A).

### TECHNICAL FIELD

The present invention relates to an epoxy resin composition for outdoor electrical insulation and a component for outdoor electrical insulation.

### BACKGROUND ART

Epoxy resins, which have good mechanical characteristics and a high specific resistance, are often used as components for electrical insulation. Epoxy resins, when intended to be used outdoors as components for electrical insulation, need to have sufficient weatherability to prevent degradation of electrical insulating properties due to rainwater and other factors.

For example, Patent Literature 1 and Patent Literature 2 describe methods for imparting weatherability. In these methods, a hydroxyl-terminated polysiloxane or a polysiloxane/polyether copolymer is added to an epoxy resin composition so as to increase the hydrophobicity (water repellency) of a cured product of the epoxy resin composition. However, such an epoxy resin composition has poor liquid stability because the hydroxyl-terminated polysiloxane has poor compatibility with epoxy resins, thus causing problems in actual use.

### CITATION LIST

### Patent Literature

Patent Literature 1: JP-A H11-147942

Patent Literature 2: JP-T 2002-531672

### SUMMARY OF INVENTION

### Technical Problem

The present invention aims to provide an epoxy resin composition having excellent liquid stability while maintaining mechanical characteristics, electrical insulating properties, and water repellency required for outdoor use as a component for electrical insulation.

### Solution to Problem

As a result of extensive studies to solve the above problem, the present inventor has found that it is possible to obtain an epoxy resin composition having excellent liquid stability while maintaining mechanical characteristics, electrical insulating properties, and water repellency required for outdoor use as a component for electrical insulation, if a glycidyl group-containing polysiloxane having excellent compatibility with epoxy resins is used instead of hydroxyl-terminated polysiloxane and if the epoxy resin, the glycidyl group-containing polysiloxane, and a dispersant are used in a weight ratio within a specific range. Thus, the present invention was accomplished.

Specifically, the epoxy resin composition for outdoor electrical insulation of the present invention contains an epoxy resin (A), 0.5 to 0.99 parts by weight of a glycidyl group-containing polysiloxane (B) based on 100 parts by weight of the epoxy resin (A); and 0.1 to 1.0 part by weight of a dispersant (C) based on 100 parts by weight of the epoxy resin (A).

Preferably, in the epoxy resin composition for outdoor electrical insulation of the present invention, the glycidyl group-containing polysiloxane (B) is an organopolysiloxane having two or more glycidyl groups.

Preferably, in the epoxy resin composition for outdoor electrical insulation of the present invention, the epoxy resin (A) is at least one of an alicyclic epoxy resin and an aliphatic epoxy resin.

Preferably, in the epoxy resin composition for outdoor electrical insulation of the present invention, the dispersant (C) is a polymer having a carboxylic acid group in the molecule or polyethylene glycol.

Preferably, the epoxy resin composition for outdoor electrical insulation of the present invention further contains silica or alumina as an inorganic filler (D).

Preferably, the epoxy resin composition for outdoor electrical insulation of the present invention further contains an alicyclic acid anhydride as a curing agent (E).

A cured resin of the present invention is a cured product of an epoxy resin composition,

the water contact angle as measured according to JIS R3257 is 90° or greater, and

the flexural strength as measured according to JIS K6911 is 120 MPa or more, and the decrease in the flexural strength after weatherability test at 1.55 kW/m² and 65° C. for 100 hours with 10 minutes of rain per two-hour duration is less than 10%.

Preferably, in the cured resin of the present invention, the epoxy resin composition contains an epoxy resin (A), 0.5 to 0.99 parts by weight of a glycidyl group-containing polysiloxane (B) based on 100 parts by weight of the epoxy resin (A), and 0.1 to 1.0 part by weight of a dispersant (C) based on 100 parts by weight of the epoxy resin (A).

Preferably, in the cured resin of the present invention, the glycidyl group-containing polysiloxane (B) is an organopolysiloxane having two or more glycidyl groups.

Preferably, in the cured resin of the present invention, the epoxy resin (A) includes at least one of an alicyclic epoxy resin and an aliphatic epoxy resin.

Preferably, in the cured resin of the present invention, the dispersant (C) is a polymer having a carboxylic acid group in the molecule or polyethylene glycol.

Preferably, in the cured resin of the present invention, the epoxy resin composition further contains silica or alumina as an inorganic filler (D).

The component for outdoor electrical insulation of the present invention includes the cured resin of the present invention.

### Advantageous Effects of Invention

The present invention provides an epoxy resin composition for outdoor electrical insulation containing a glycidyl group-containing polysiloxane having excellent compatibility with an epoxy resin, wherein the epoxy resin, the glycidyl group-containing polysiloxane, and a dispersant are used in a, weight ratio within a specific range. Thus, the epoxy resin composition has excellent liquid stability while maintaining mechanical characteristics, electrical insulating properties, and water repellency, and can be suitably used in applications for outdoor electrical insulation.

In addition, the component for outdoor electrical insulation of the present invention, which includes the cured resin of the present invention, has excellent weatherability.

### DESCRIPTION OF EMBODIMENTS

### Epoxy Resin Composition for Outdoor Electrical Insulation

The epoxy resin composition for outdoor electrical insulation of the present invention contains an epoxy resin (A), 0.5 to 0.99 parts by weight of a glycidyl group-containing polysiloxane (B) based on 100 parts by weight of the epoxy resin (A), and 0.1 to 1.0 part by weight of a dispersant (C) based on 100 parts by weight of the epoxy resin (A).

### <Epoxy Resin (A)>

The epoxy resin (A) is not particularly limited. Examples include alicyclic epoxy resins, aliphatic epoxy resins, bisphenol type epoxy resin, novolac type epoxy resin, and diglycidyl ester resin. Preferred among these are alicyclic epoxy resins and aliphatic epoxy resins in view of the weather resistance. These may be used alone or in combination of two or more thereof.

Any alicyclic epoxy resin may be used. Examples include diglycidyl hexahydrophthalate and diglycidyl tetrahydrophthalate. These may be used alone or in combination of two or more thereof.

Any aliphatic epoxy resin may be used. Examples include 1,4-butanediol diglycidyl ether and 1,6-hexanediol diglycidyl ether. These may be used alone or in combination of two or more thereof.

The amount of the epoxy resin (A) is not particularly limited, but it is preferably 5 to 50% by weight, more preferably 20 to 30% by weight in the epoxy resin composition for outdoor electrical insulation of the present invention. If the amount is less than 5% by weight, the mechanical strength of the cured product may be insufficient. Likewise, if the amount is more than 50% by weight, the mechanical strength of the cured product may be insufficient.

### <Glycidyl Group-Containing Polysiloxane (B)>

The glycidyl group-containing polysiloxane (B) is not particularly limited as long as it is a compound having a siloxane bond (Si—O—Si bond) with a glycidyl group. Examples include monoglycidyl ether polysiloxane, diglycidyl ether polysiloxane, triglycidyl ether polysiloxane, and tetraglycidyl ether polysiloxane. These may be used alone or in combination of two or more thereof.

The number of glycidyl groups of the glycidyl group-containing polysiloxane (B) is not particularly limited, but it is preferably at least two, more preferably at least three, still more preferably at least four per molecule. If the number of glycidyl groups is less than two, the resulting epoxy resin composition may be phase-separated.

In view of the compatibility with the epoxy resin (A), the glycidyl group-containing polysiloxane (B) is preferably an organopolysiloxane having two or more glycidyl groups.

The amount of the glycidyl group-containing polysiloxane (B) is not particularly limited as long as it is 0.5 to 0.99 parts by weight based on 100 parts by weight of the epoxy resin (A), but it is preferably 0.8 to 0.95 parts by weight. If the amount is less than 0.5 parts by weight, the water repellent effect may be insufficient. If the amount is more than 0.99 parts by weight, the epoxy resin composition will be phase-separated, and as a result, the epoxy resin composition may have poor liquid stability, or the resulting cured product may exhibit insufficient water repellency and insufficient weatherability.

### <Dispersant (C)>

The dispersant (C) in the epoxy resin composition for outdoor electrical insulation of the present invention can improve the dispersibility. The dispersant (C) is not particularly limited. Examples include a polymer having a carboxylic acid group in the molecule, polyethylene glycol, and polypropylene glycol. Preferred among these are a polymer having a carboxylic acid group in the molecule and polyethylene glycol because these dispersants can more effectively improve the dispersibility of the epoxy resin composition for outdoor electrical insulation of the present invention. These may be used alone or in combination of two or more thereof.

The amount of the dispersant (C) is not particularly limited as long as it is 0.1 to 1.0 part by weight based on 100 parts by weight of the epoxy resin (A). If the amount is less than 0.1 parts by weight, the effect of improving the dispersibility will be insufficient. As a result, the epoxy resin composition may have poor liquid stability. If the amount is more than 1.0 part by weight, the resulting cured product may exhibit insufficient water repellency and insufficient weatherability.

The epoxy resin composition for outdoor electrical insulation of the present invention may contain any other components in addition to the epoxy resin (A), the glycidyl group-containing polysiloxane (B), and the dispersant (C). Other components are not particularly limited. Examples include an inorganic filler (D), a curing agent (E), and core-shell rubber.

### <Inorganic Filler (D)>

The inorganic filler (D) in the epoxy resin composition for outdoor electrical insulation of the present invention can reduce the shrinkage, heat generation, and expansion, and can improve the elastic modulus, mechanical strength, and crack resistance. The inorganic filler (D) is not particularly limited. Examples include silica (e.g., crystalline silica and fused silica), alumina, dolomite, calcium carbonate, talc, and wollastonite. Preferred among these are silica and alumina for reducing the shrinkage and improving the mechanical strength. These may be used alone or in combination of two or more thereof.

The amount of the inorganic filler (D), if present, in the epoxy resin composition for outdoor electrical insulation of the present invention is not particularly limited, but it is preferably 30 to 85% by weight, more preferably 60 to 75% by weight in the composition. If the amount is less than 30% by weight, the inorganic filler may be insufficiently dispersed and deposited. If the amount is more than 85% by weight, the viscosity may become too high, and air bubbles may thus be generated.

### <Curing Agent (E)>

The epoxy resin composition for outdoor electrical insulation of the present invention may contain the curing agent (E). The curing agent (E) is not particularly limited. Examples include alicyclic acid anhydrides and aliphatic acid anhydrides. Preferred among these are alicyclic acid anhydrides in view of the mechanical strength of the cured product.

Any alicyclic acid anhydride may be used. Examples include hexahydrophthalic anhydride, tetrahydrophthalic anhydride, methyl-hexahydrophthalic anhydride, and methyl-tetrahydrophthalic anhydride.

These examples of the curing agent (E) may be used alone or in combination of two or more thereof.

The amount of the curing agent (E), if present, in the epoxy resin composition for outdoor electrical insulation of the present invention is not particularly limited, but it is preferably 60 to 120 parts by weight, more preferably 80 to 100 parts by weight based on 100 parts by weight of the epoxy resin (A). If the amount is less than 60 parts by weight, the epoxy resin composition may not be sufficiently cured, and the mechanical strength of the cured product may be insufficient. Likewise, if the amount is more than 120 parts by weight, the mechanical strength of the cured product may be insufficient.

The epoxy resin composition for outdoor electrical insulation of the present invention is suitably applicable for outdoor electrical insulation. Examples of such applications include outdoor mold transformers in outdoor facilities such as transformer substations and transmission substations, outdoor support insulators, and outdoor bushings.

### <<Cured Resin>>

The cured resin of the present invention is a cured product of an epoxy resin composition,

the water contact angle as measured according to JIS R3257 is 90° or greater, and

the flexural strength as measured according to JIS K6911 is 120 MPa or more, and the decrease in the flexural strength after weatherability test at 1.55 kW/m² and 65° C. for 100 hours with 10 minutes of rain per two-hour duration is less than 10%.

The epoxy resin composition in the cured resin of the present invention is the same as the epoxy resin composition for outdoor electrical insulation of the present invention described above.

In the cured resin of the present invention, the water contact angle as measured according to JIS R3257 is not particularly limited as long as it is 90° or greater, but it is preferably 95° or greater.

In the cured resin of the present invention, the flexural strength as measured according to JIS K6911 is not particularly limited as long as it is 120 MPa or more, but it is preferably 130 MPa or more, more preferably 140 MPa or more. In addition, the decrease in the flexural strength after weatherability test at 1.55 kW/m² and 65° C. for 100 hours with 10 minutes of rain per two-hour duration is not particularly limited as long as it is less than 10%, but it is preferably less than 7%, more preferably less than 5%.

In the cured resin of the present invention, the glass transition temperature (Tg) is not particularly limited, but it is preferably 105° C. or higher, more preferably 110° C. or higher.

### <<Component for Outdoor Electrical Insulation>>

The component for outdoor electrical insulation of the present invention characteristically includes the cured resin of the present invention.

The component for outdoor electrical insulation is not particularly limited. Examples include outdoor mold transformers, outdoor support insulators, and outdoor bushings.

### EXAMPLES

The present invention is described with reference to examples, but the present invention is not limited to the following examples. The terms “part(s)” and “percent” means part(s) by weight and percent by weight, respectively, unless otherwise specified.

### (Materials Used)

The following materials were used in the examples and comparative examples below.

Epoxy Resin (A)

Alicyclic diglycidyl ester (Nagase ChemteX Corporation, DENATITE CY184J)

Glycidyl Group-Containing Polysiloxane (B)

Epoxy silicone (Dow Corning Toray Co., Ltd., SF8421)

Siloxane Other than the Glycidyl Group-Containing Polysiloxane (B)

### Alkylsiloxane (Dow Corning Toray Co., Ltd., SH230)

Polyether-modified silicone (Dow Corning Toray Co., Ltd., FZ2110)
Fluorine-modified silicone (Dow Corning Toray Co., Ltd., FB1265)

Dispersant (C)

Polyethylene glycol (NOF Corporation, PEG400)

Inorganic Filler (D)

Crystalline silica (Fukushima Yogyo Co., Ltd., M151)

Curing Agent (E)

A mixture of 4-methyl-hexahydrophthalic anhydride and hexahydrophthalic anhydride (Hitachi Chemical Co., Ltd., MH700)

### (Evaluation Methods)

Liquid Stability

The epoxy resin composition was left standing and stored at 40° C. for 168 hours. The presence or absence of deposition was visually observed.

Good: No deposition was observed.
Poor: Deposition was observed.

Water Repellency

The water contact angle of the cured product obtained as described below was measured according to JIS R3257.

Weatherability

The cured product obtained as described below was subjected to measurement of the flexural strength according to JIS K6911. The flexural strength was measured before and after exposure to Metaling Weather Meter (Suga Test Instruments Co., Ltd., “M6T” at 1.55 kW/m² and 65° C. for 100 hours with 10 minutes of rain per two-hour duration).

Glass Transition Temperature (Tg)

The glass transition temperature was measured by DSC using DSC822e available from Mettler-Toledo International Inc.

### Examples 1 to 5 and Comparative Examples 1 to 9

The components were mixed in a weight ratio shown in Table 1 below. Thus, an epoxy resin composition was obtained. The epoxy resin composition was injected into a metal mold and then heated at 100° C. for 3 hours, and additionally heated at 130° C. for 12 hours for curing. Thus, a cured product was obtained. In each example and each comparative example, the liquid stability of the epoxy resin composition, and the water repellency, weatherability, and glass transition temperature (Tg) of the cured product were evaluated by the methods described above. Table 1 shows the results.

TABLE 1

| | | Examples | | | | | Comparative Examples | | | | | | | | |
|---|---|---|---|---|---|---|---|---|---|---|---|---|---|---|---|
| | | 1 | 2 | 3 | 4 | 5 | 1 | 2 | 3 | 4 | 5 | 6 | 7 | 8 | 9 |
| Epoxy resin (A) | DENATITE | 100 | 100 | 100 | 100 | 100 | 100 | 100 | 100 | 100 | 100 | 100 | 100 | 100 | 100 |
| | CY184J | | | | | | | | | | | | | | |
| Glycidyl | SF8421 | 0.5 | 0.95 | 0.99 | 0.95 | 0.95 | — | — | — | — | 0.1 | 0.5 | 0.95 | 5 | 5 |
| group-containing | | | | | | | | | | | | | | | |
| polysiloxane (B) | | | | | | | | | | | | | | | |
| Alkylsiloxane | SH230 | — | — | — | — | — | — | 0.5 | — | — | — | — | — | — | — |
| Polyether-modified | FZ2110 | — | — | — | — | — | — | — | 0.5 | — | — | — | — | — | — |
| silicone | | | | | | | | | | | | | | | |
| Fluorine-modified | FB1265 | — | — | — | — | — | — | — | — | 0.5 | — | — | — | — | — |
| silicone | | | | | | | | | | | | | | | |
| Dispersant (C) | PEG400 | 0.5 | 0.5 | 0.5 | 0.1 | 1 | — | — | — | — | — | — | — | 0.5 | 5 |
| Inorganic filler (D) | M151 | 290 | 290 | 290 | 290 | 290 | 290 | 290 | 290 | 290 | 290 | 290 | 290 | 290 | 290 |
| Curing agent (E) | MH700 | 88 | 88 | 88 | 88 | 88 | 88 | 88 | 88 | 88 | 88 | 88 | 88 | 88 | 88 |
| Liquid stability | | Good | Good | Good | Good | Good | Good | Poor | Poor | Poor | Poor | Poor | Poor | Poor | Good |
| Water repellency | | 96 | 95 | 95 | 95 | 95 | 55 | 71 | 70 | 75 | 65 | 73 | 97 | 105 | 103 |
| (water contact angle ° ) | | | | | | | | | | | | | | | |
| Weatherability | Before exposure | 143 | 135 | 135 | 136 | 134 | 145 | 145 | 139 | 138 | 145 | 144 | 143 | 125 | 108 |
| (flexural strength Mpa) | After exposure | 135 | 135 | 135 | 135 | 133 | 118 | 130 | 130 | 128 | 137 | 136 | 135 | 118 | 96 |

| | | | | | | | | | | | | | | |
|---|---|---|---|---|---|---|---|---|---|---|---|---|---|---|
| Glass transition | 116 | 115 | 115 | 115 | 115 | 116 | 115 | 115 | 113 | 116 | 116 | 115 | 108 | 95 |
| temperature (Tg) | | | | | | | | | | | | | | |

1. An epoxy resin composition for outdoor electrical insulation, comprising:
an epoxy resin (A);
0.5 to 0.99 parts by weight of a glycidyl group-containing polysiloxane (B) based on 100 parts by weight of the epoxy resin (A); and
0.1 to 1.0 part by weight of a dispersant (C) based on 100 parts by weight of the epoxy resin (A).

2. The epoxy resin composition for outdoor electrical insulation according to claim 1,
wherein the glycidyl group-containing polysiloxane (B) is an organopolysiloxane having two or more glycidyl groups.

3. The epoxy resin composition for outdoor electrical insulation according to claim 1,
wherein the epoxy resin (A) is at least one of an alicyclic epoxy resin and an aliphatic epoxy resin.

4. The epoxy resin composition for outdoor electrical insulation according to claim 1,
wherein the dispersant (C) is a polymer having a carboxylic acid group in the molecule or polyethylene glycol.

5. The epoxy resin composition for outdoor electrical insulation according to claim 1, further comprising silica or alumina as an inorganic filler (D).

6. The epoxy resin composition for outdoor electrical insulation according to, further comprising an alicyclic acid anhydride as a curing agent (E).

7. A cured resin,
wherein the cured resin is a cured product of an epoxy resin composition,
the water contact angle as measured according to JIS R3257 is 90° or greater, and
the flexural strength as measured according to JIS K6911 is 120 MPa or more, and the decrease in the flexural strength after weatherability test at 1.55 kW/m² and 65° C. for 100 hours with 10 minutes of rain per two-hour duration is less than 10%.

8. The cured resin according to claim 7,
wherein the epoxy resin composition contains an epoxy resin (A), 0.5 to 0.99 parts by weight of a glycidyl group-containing polysiloxane (B) based on 100 parts by weight of the epoxy resin (A), and 0.1 to 1.0 part by weight of a dispersant (C) based on 100 parts by weight of the epoxy resin (A).

9. The cured resin according to claim 8,
wherein the glycidyl group-containing polysiloxane (B) is an organopolysiloxane having two or more glycidyl groups.

10. The cured resin according to claim 8,
wherein the epoxy resin (A) comprises at least one of an alicyclic epoxy resin and an aliphatic epoxy resin.

11. The cured resin according to claim 8,
wherein the dispersant (C) is a polymer having a carboxylic acid group in the molecule or polyethylene glycol.

12. The cured resin according to claim 8,
wherein the epoxy resin composition further contains silica or alumina as an inorganic filler (D).

13. A component for outdoor electrical insulation comprising:
the cured resin according to claim 7.
